(19) United States
(12) Patent Application Publication
(10) Pub. No.: US 2005/0149741 A1
(43) Pub. Date: Jul. 7, 2005

(54) Autorisations, regulation, characterisation, localisation, locking and theft security system (here also referred to as lock-loop dss)

(76) Inventor: Roger M. Humbel, Dattwil (CH)

Correspondence Address: ZOLLINGER & BURLESON LTD., PO BOX 2368, NORTH CANTON, OH, 44720, US

(21) Appl. No.: 10/521,224

(22) PCT Filed: Jul. 14, 2003
(86) PCT No.: PCT/IB03/02809

(30) Foreign Application Priority Data
Jul. 13, 2002 (CH) 1260/02

(51) Int. Cl. H04K 1/00

(52) U.S. Cl. 713/186

(57) ABSTRACT

Combination of a loop lockable with a lock (itself) which carries a license number or a numeric, alphanumeric, or bar code that can be registered on the internet or on a mobile phone portal which is destroyed in the case of theft or criminal violent influence, and also can be used or installed integrated for or on chains or locks themselves, (motor) cycles (through the spokes, hubs, gears changers etc.), ski bindings, kickboards, cars, boats, aircraft, stationary objects and can be equipped with an electrical circuit and with a connection or interruption to an electrical (switching) devices and can also carry a chip which gives a signal to the number registered on the internet or on the mobile phone portal and, e.g., is integrated in a screw head.

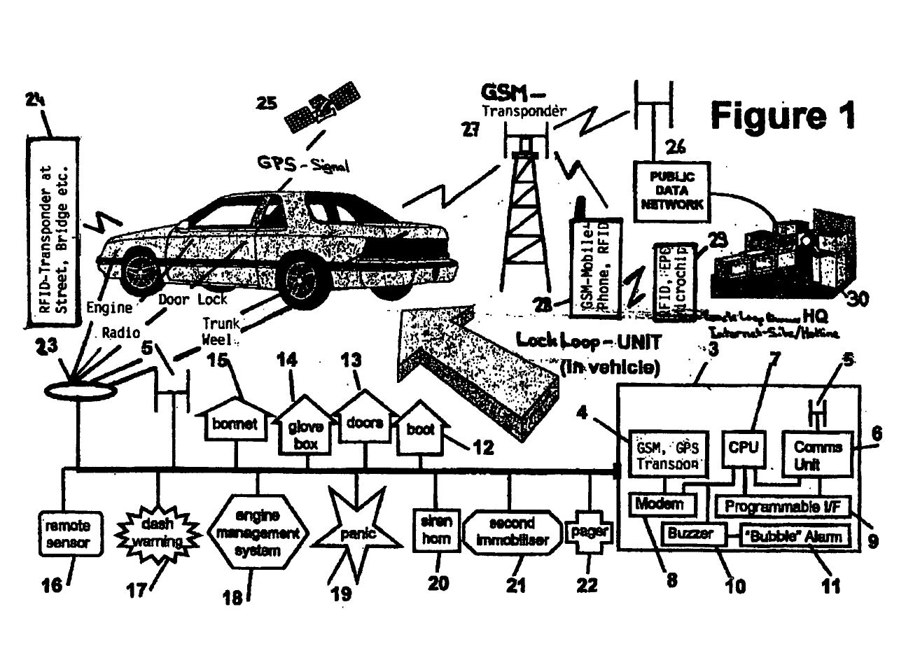

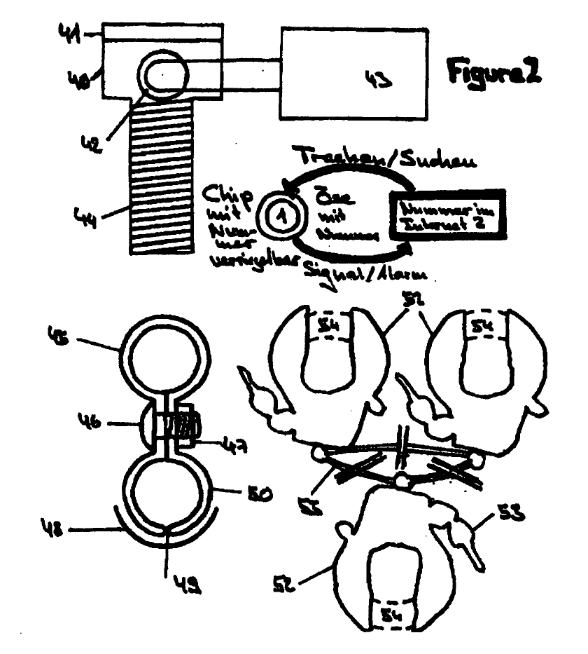

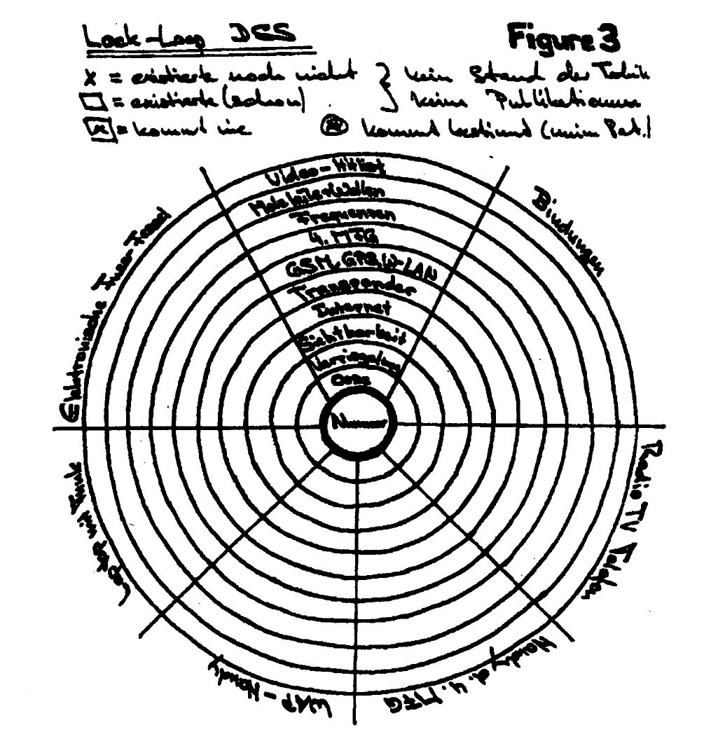

The invention concerns a loop or several loops that can be locked or encrypted with no, one, or several locks or algorithms. For example, microchips with their transistors are closable current-switching circuits, wherein the transistor is the closing lock and the electric current circuit is the loop. Each loop and each lock, together as a unit, carries a number or several numbers registered on the internet, on a mobile phone portal, or another database, which have indices and functions; the numbers optionally can be affixed to products or even integrated in them. Carried on, attached to, or integrated in the locks can be one or more transmitters, transponders, or GSM-SIM card chips as radio interfaces which can emit/receive a signal, possibly encrypted, to the number(s) registered on the internet, the mobile phone portal, or the like; these can trigger an alarm when destruction, theft, misappropriation, or the like occurs and also identify the location of the loop which, however, also can be located with other mobile and/or other stationary radio transmitting/receiving units.

The first stage or level of the security solution is a purely mechanical-visual one: whether or not the number is or is not destroyed. For policemen, garage managers, and used car buyers, this is the simplest method of determining the legal owner of a vehicle (over the Internet). Driving cars with a destroyed or missing number should no longer be possible because one doing so would have much to explain just due to this second security step.

The second step of the safety solution is that, upon destruction and interruption of the loops, an alarm always is sent immediately via the internet number to a mobile telephone, a police center, etc.

Any product equipped with this authorization-, determination-, designation-, authorization-, location-, locking and theft security system can be located, at any time, by various GSM, GPS, W-LAN, etc., network coverages. A vehicle or other product no longer can be moved without authorization of the owner; a physical car key no longer is necessary and cannot be stolen because, via the mobile telephone with a code or a finger-print, the owner at any time can open and start the vehicle or turn off and lock it.

This combination of features—a lockable (intentional as well as unintentional) loop, hat, cap, ball, or box with one, several or no locks, latches, bars, or barriers that carry a (temporal, variable, or encrypted) license number and/or a numerical, alpha-numerical, or just a bar code that can be registered on the internet or a mobile phone portal, and, when destroyed by theft or criminal force and/or with any other minor physical sensory influence, triggers an alarm—can be used for or mounted on chains or regular locks themselves, (motor)bicycles (through the spokes, hubs, gear shifts, etc.); kickboards; cars; boats; airplanes; real property; or suitcases; cassettes; mobile telephones; computers; laptops; TVs; projectors; (electrical) devices as well as any cable or (handheld) weapons; clocks/watches; clothing; (chastity) belts and naturally human or animal limbs; plants; as well as screws, nuts, nails, needles, threads, buttons, packages, housings; and ski bindings. It can be equipped with an electrical circuit with connection or interruption to electrical (switching) devices and also can carry a transmitter and/or a chip which sends an (encrypted) signal to the number registered in the internet or on the mobile phone portal or other database.

The arrangement of the number, lock, and loops as well as the transmitters and/or chips easily can be constructed and configured such that they function without damage for years but, with slight damage or injury, are destroyed or have another function such as triggering an alarm. The loop, the number, the electrical circuit thus also can form a unit with the number such as, e.g., a watch face. The lock/loop itself can form such a unit as well as any other arrangement with a loop, e.g. a screw, nut, nail, needle, thread, button, rod, rivet, ring, plate, ball or box with loop and number. Also, a ball or box can be locked additionally with a normal key system with or without radio transmission; from the ball or box cables emerge as loops which have a protected transmitter/transponder or transmitter inside the ball or box itself

The original principle of the lockable loop with internet number is similar to that described in the known patent application for safety bindings, WO 02/062432 (U.S. Publ. Pat. Appl. No. 2004/0041365 A1):
“A turning folding lever which after correct attachment is turned over a projecting loop 37 of clamping part 15 and locked by means of a small lock 100 . . . With the small lock, the separated clamping part and clamped part can be prevented from being brought together again; in this way, one has an excellent mechanical theft-proofing device. On the loop and in a highly visible place on that safety binding or interface also is placed a numeric, alphanumeric, or bar code 39 which is registered in a list 40 of the manufacturer on the internet and where the owner/legally recognized purchaser is granted the possibility of protecting his property himself or to have it protected with his name. In this way, stolen safety bindings/interfaces can be identified quickly, because the highly visible loop and associated code are destroyed when the lock is criminally removed. In this and other ways, insurance companies can have recourse to sanctions in case of an accident because presently these insurers want to have each new accident with the interface statistically proven; we are prepared to accept only registered accidents as real accidents because any snowboard accident could be verified in the statistics in connection with the new interface or otherwise, which would be wrong. Also, very simply and easily, illicit Asian or Eastern Europe imitations can be prevented.”

Coins, paper currency, and credit cards likewise can be equipped with a (lockable) loop, microchip, or transponder and store additional information about time, place and past owners. On the credit card all personal data are accessible. When coins, paper currency, or credit cards are damaged or destroyed unintentionally, the data and values can be restored or, in the case of criminal destruction, blocked until an explanation can be made. The coins, paper currency, or credit cards therefore can be officially devalued or valued.

The loop can be locked or opened with (a screw and/or nut, with) a lock, with a loop or lock, or be locked/encrypted serially or in parallel or a combination of these.

The lock can be affixed to, on, at, for, in place of the loop and vice versa.

The loop has a brightly colored finish. A light or sound signal to the loop or the EPC tag indicates connection to the radio interface (mobile phone). The number on the loop is engraved with a 1 mm or 0.5 or 0.3 or 0.1 or 0.05 or 0.03 or 0.001 mm laser (all the way through or only partially).

For bicycles, a (clip with) loop is fastened to or in the frame or affixed to or integrated with other components (e.g., hubs, axles, rims, saddle, steering mechanism, grips, brakes, tire), which themselves can be loops or even locks.

The lockable loop with internet number can be integrated into all products as a RFID-EPC tag (for data security reasons, for safety reasons for the dealers, and many other reasons).

### EXPLANATION OF NOVELTY RELATIVE TO THE STATE OF THE ART

Between the lock-loop (locking) and only the radio feature exists a rather large difference. The LL feature is developed further by the radio feature (calling to the number on the internet). Both are inventive and new, as pointed out by the following. All new products, including those with only a radio feature and a number on the internet, infringe this application, even laptops and also EPC tags, for which here follows proof on the basis of mobile phones, etc. Regardless, certainly every self-lockable product with a number to call on in the internet falls under this patent application.

Regarding laptops, they now have the same functions, features, and chips (and the same molecules) as mobile phones, but that such a signal transmission (detecting, etc., locking, or disconnecting) also can be done to laptops equipped with Centrino™ chipsets; certainly not for this purpose only is the application directed but also for laptops, bindings/linkages, vehicles, etc. Mobile phones never had such a (LL) radio feature to transmit to themselves a locking signal, not to mention track themselves; in the case of laptops, etc., they did not yet have it, and now they have it (with Centrino™ chipsets and Theft Guard™ software in BIOS), as claimed here which is new for laptops. The (LL) radio feature is new, and it is new with laptops; with presently available (WAP) mobile phones, such a (intentional locking/opening and then tracking) signal transmission still does not exist at all, although it probably can be made available soon (by us). A patent does, after all, claim that which is new! Anyone (such as, e.g., a laptop manufacturer) who asserts that the (LL) radio feature on laptops is state-of-the-art is presumptuous. It is and remains new even if it functions with the same molecules, frequencies, and features as mobile phones and achieves the best solution with Theft Guard. As formulated, it is new and inventive, the same as with Centrino™ laptops.

I could formulate the claim otherwise: .(LL) radio feature with/via UMTS and/or. 4th generation (4 G) mobile phones. This does not exist yet. No, it does, because the frequencies were already existing and are state of the art like molecules. So, what can still be patented if everything consists of molecules and waves? Nothing. Fortunately, by definition, it must be possible that everything (every feature combination) that is new, inventive, and commercially marketable can be patented. Lock-Loops with numbers on Centrino™ laptops which send a signal to an internet number are new. In addition, this LL feature is new with 4 G mobile phones. All lockable (but not non-lockable) traceable currently available mobile phones, as well as EPC tags, belong to this invention.

In particular, my new, small mini-invention validly can claim 4 G mobile phones with the LL feature because my application claims also the LL feature for electrical devices, such as computer and mobile phones, as well as all new products with the LL feature. Without an alternative, I have contacted IBM Switzerland and Swisscom Mobile for this reason. I need not again ask a mobile phone manufacturer for other new subsequent generation developments or ask them to share their information because, simply, all new products, even next-generation products, with the LL feature fall within the scope of protection afforded by this patent application. I add this here as a certain declaration to this Loop-Internet number patent.

WAP mobile phones and electronic foot shackles for home confinement could be considered as state-of-the-art and affect the novelty of the lockable loop with number on the internet. However, these foot shackles scarcely have a number on themselves, as is the case with the loops or laptops or bicycles and vehicles as a means for monitoring and above all deterring theft. Anyway, these electronic shackles cannot be locked, or especially unlocked, with one's own radio device; they are the pure opposite. Only other, authorized persons can unlock them (without triggering an alarm).

It is completely logical and comprehensible, and also not unfair, that new laptops with the W-LAN feature, new 4 G mobile phones as well as current mobile phones, and EPC tags with this LL feature require a license. All new products with these new features infringe the claims of this patent. Even just (new) self-locking microchips with Internet number probably could be claimed. (EPC tags on cola cans—except the new, next-generation ones which probably will never come about because the present generation already is the last and best)—are not new, but EPC tags in clothes like trousers for data protection and authorization reasons surely are. If only I could have claimed a few less features in contrast to (intentionally as well as unintentionally) self lockable loops with a number on the internet.

Certainly, also covered here are even presently available mobile phones which could be locked (by one's own authorization), for data protection and authorization reasons, for legally permissible locations. Such precise features do not yet exist with mobile phones. Nevertheless, WAP-mobile phones in existence before this invention are not covered, but licenses must be paid as soon as one can lock them with all the lock-loop functions.

Quite surely, Theft Guard™ of Phoenix locks laptops, so laptop manufacturers must pay royalties for the new lock-loop functions. This is exactly the same as with mobile phones and EPC tags where the patent claims self-executed locking (for reasons of data security and authorization). Even self-locking EPC tags for data protections reasons did not previously exist.

### EXPLANATION OF INVENTIVE ACTIVITY

The following explanation also should prove that, for laptops with the new radio feature (with the Intel Centrino™ Pentium M processor), my previously submitted patent application was not only new but also inventive.

Originally, the DSS solution was made for bindings/links in which, for protection against theft, a loop can be locked with a small lock. The security that this provided seemed too little; it was found that better protection could be achieved with a number on the loop because, in the case of theft and/or destruction of the loop, a thief having the product without an intact number would be in great need of an explanation for towards colleagues, officials, etc. For bicycles, a similar solution—with a ring affixed to the frame and having a number registered on the internet—was available under the name CYCLO. Because a (lockable) loop is no (not lockable) ring, this originally was included in the interface safety binding patent as a dependent claim.

I then recognized and discovered that an electrical circuit could be placed in the loop for alarm purposes, that a transmitter for alarm signal transmission could be attached, and even that a microchip, which itself is comprised of electric circuits and/or loops, could be included. I realized that the transmission/transmitter solution of a chip with a number on the internet is also a feature of the loop with number on the internet, which therefore can be used in new products as the basis for further lock-loop based DSS and infinitely many other features. Other products (electronic like non-electronic) which do not yet have such a transmission/transmitter solution (like laptops, WAP-mobile phones, projectors, etc.) also can be equipped with one so that they also can be integrated with this lock-loop DSS feature. Thereby also was invented the Centrino™ Pentium M processor radio feature also for laptops. QED.

The loop-internet number radio feature alone, however, also is new in the case of new laptops, etc., as well as with current mobile phones and EPC tags in respect to the important abilities to lock (and track) these devices for privacy purposes, data protection, etc.

After the filing of a patent application on 13 Jun. 2002, Swisscom Mobile was approached regarding vehicle and laptop tracking systems. In autumn 2002, Daimler-Chrysler was shown and, in December 2002, IBM Switzerland was contacted regarding integration of a small Lock-Loop box into laptops as a locking and detection solution, which was thought to sell as little box. Two months later, Intel unexpectedly provided via its Centrino™ radio feature the basis for the Lock-Loop box and, less than three months after that, Phoenix Technologies via its Theft Guard™ product introduced soft-ware needed to run lock-loop box. N.B., I had filed on all features of this Lock-Loop box as early as 13 Jun. 2002, i.e., on the one hand, the necessary radio feature and, on the other hand, the software locking feature for locking. Naturally, it also needs an internet web-site, hotline, etc.

A patent application for only a transmitter in a laptop probably also is inventive, but on one hand, other than W-Lan Centrino™ chips, I am not aware of such integrated radio systems in laptops (because all previous ones were only plug-in cards), and, on the other hand, Intel, Phoenix Technologies, etc., and every other laptop manufacturer such as, e.g., IBM, did not think to patent such a solution. Last but not least, if another inventor already filed for such a patent before me, Intel or IBM and all other laptop manufacturers certainly would have found this patent and shown it to me. Anyway, this “transmitter in laptop” is a different feature from “loop with transmitter to a number on the internet”; therefore, laptop tracking services must pay me, as well as any other inventor, licenses. Laptops with radio transmitters in the PCMCIA slots or with plug-in cards unfortunately do not infringe this invention, because they are not firmly installed transmitters and are state of the art. However, this fact convinces me all the more that Centrino™ laptop tracking services (will) infringe this patent.

Truly, I have claimed with the DSS not merely a theft-security system with a loop and a number on the Internet. If one examines all claims in the application, one sees an infinitely large number of functions (locking, blocking, connecting, informing, implementing, managing, etc.) for mobile phones and laptops. Therefore, the counter argument that Centrino™ laptops having no DSS nullify my loop-internet number transmission claim is invalid. Regardless, in the future, all laptops also will have the Theft Guard™ product and then additionally violate this DSS lock feature.

In the worst case, I also can make even a correct “sophisticated” twisting of words to strengthen my assertions made here. The first two lines in my first patent claim read: Theft-security system consisting of a loop lockable with a lock or one or more loops lockable with several locks . . . (which as a unit carries a number registered on the internet). “Theft security system,” I was greatly annoyed that my patent attorney Mr. Spierenburg had formulated it in such a way. But now I can also live with this very well, because ultimately many functions on laptops only involve assuring that information cannot be stolen. Transistors and microchips are nothing but closable (or lockable) and openable circuits or loops. Therefore, the transistor in the chip as a lock closes and locks circuits or loops precisely as I had formulated it in the first two lines of my first claim. No wonder I was so overjoyed when it became clear to me with the chips that these chips themselves, in the true sense of the word, consist of loops (circuits) and locks (transistors) and in addition precisely could themselves send the signal to the number on the internet and also equally still carry the number literally in themselves.

I hope that you will agree with my explanations and also find that I invented my loop internet number radio feature for laptops. However, this still does not make it entirely clear whether this is inventive, because WAP cell phones also already possessed the same loop-internet number radio feature. This is or was, however, for cell phones which (in the case of the loops) function with the same molecules, waves and frequencies as laptops. So something with the same molecules, waves and frequencies (also in the case of the loops) cannot be invented or one is not acting inventively. It (including in the case of loops) must be invented for another feature or with another combination of features in order to be inventive. Laptops already are/have another feature or another combination of features than with/in the case of cell phones only because they have a different name and also could not communicate directly on the internet (had no WAP, no GSN or no (W-LAN) transponders or had no antennas) and are equipped with some other functions wherefore it is already inventive for that reason. QED 2.

Note that the first cell phone with a W-LAN feature similar to that in Centrino™ laptops was introduced by Motorola only at the beginning of 2003. Did Motorola also need to pay me licenses? Yes, because this new feature did not yet exist before I had just invented it. This is precisely the same thing as I have already written above with the 4 G mobile phones regarding novelty. Therefore, actually all new products (even without radio or locking feature) which have a loop with a number on the internet must pay me licenses, because I have patented it and have repeatedly so stated. The calculation logistics necessary for this is childishly simple. Every product receives an EPC tag, and licenses must be paid to me for this.

### Central Features and Categories

This patent application contains claims for lockable loops with numbers on the internet for products like laptops with Centrino™ W-LAN function and for theft-protection and for locking and tracking of the device, as well as the same functions for EPC tags, mobile phones, standalone solutions for vehicles (including motorcycles and bicycles), and also naturally bindings/linkages and the like. For better comprehensibility, the Lock-Loop patent (like every one) is divided into two categories and outlined with the following features newly established by us:

Apparatus:

loop (chip) with number (with other information)
number in database (internet and over mobile telephone accessible to all, etc.)
the loop itself, lockable and openable (mechanically, electronically, locally, temporally, legally, or a combination of these, etc.)
visible number (on internet, mobile phone-display, or product, e.g., as a serial number)
   Method:
sending and receiving numbers (with other information as well through a transponder, i.e., the radio feature)
comparison of the (loop) numbers and information in database (number)
if number (is destroyed or) identified in database characterized: alarm signal (or locking of the loop, i.e. Lock-Loop feature or other function such as tracking of the loop over GSM, GPS, or regular radio)

Only if someone applied for an identical patent with the same radio or even LL feature, e.g., for WAP-mobile phones and all other products, in the case of laptops would this patent already have been granted to someone else. On the other hand, in the case of laptops, the radio feature as well as the LL feature cannot be designated as state-of-the-art. Naturally, someone could have applied for the radio feature, etc., only for laptops. Then it could even be that the laptop manufacturer must pay licenses twice or three times for similar, even theft-proof systems with slightly different functions.

I cannot be reproached for not having mentioned with which products this patent can find use. On the one hand, a broad assortment of products is enumerated; on the other hand, I cannot know in which products these inventive features and functions can be incorporated or which products still do not have such patent protection, like apparently the laptops. For example, I was unaware that locking EPC tags had no patent protection.

Of course this invention is uncommonly broad and, ultimately, even WAP-mobile phones will be covered, because I thought of the loop-internet number invention, and described it in my other patent applications, as early as 1998 when no WAP-mobile phone was yet marketed. Nobody probably earlier patented a WAP-mobile phone with tracking and locking feature; however, I no longer can demand licenses from them.

Additionally there are (still) no mobile phones that one can lock (himself) and track simultaneously over a GSM network. To be sure, with its settings a cellular phone (not just the SIM card) can be locked if the PIN code is incorrectly entered three times, but, as in the case of laptops, the device is gone because it still cannot be tracked.

A patent attorney called my attention to other certain eventualities, that possibly someone else, or certainly the industry, already might have applied for a patent on this. As already stated above, Phoenix Technologies, Intel, Swisscom Mobile and IBM Switzerland knew of nothing like this. Intel has no interest in applying for a patent for the laptop manufacturers, or it may have forgotten or overlooked filing such an application and selling it with the Centrino™ function, because Intel produces only chips but not laptops. The laptop manufacturers themselves did not think of patenting it when they were offered the chance to buy and integrate the Centrino™ function at the time when I had already made my invention and filed it.

Index of Terms Used

1 loop with number
2 Internet or other data base with number
3 conditions alone solution for vehicles
4 RFID-, GSM-, GPS, W-LAN transponder
5 antenna for RFID-, GSM-, GPS- W-LAN transponder
6 communication unit
7 central processing unit
8 modem
9 programmable attitudes
10 siren
11 (acoustic and visual) alert
12 lock-loop unit in the trunk
13 lock-loop unit in the doors
14 lock-loop unit in the glove drawer
15 lock-loop unit
16 central locking unit
17 instrument panel alarm system
18 engine management and locking device system
19 accident-, panic alarm system
20 siren horn
21 vehicle-style-casually
22 Pager to other conditions alone solutions
23 antenna to other EPC tags in the vehicle
24 RFID transponders at the roadside, bridges etc.
25 GPS satellites
26 Internet or other data bases
27 GSM transmitting plants and/or transponder
28 GSM mobile Tele Phone
29 RFID EPC tags
30 lock-loop number Head-Quarter
40 screw with microchip
41 microchip
42 loop
43 mechanical lock with loop
44 threads of the screw
45 double loop clip for bike-frame
46 insert screw
47 nut/mother
48 bicycle number
49 opening around clip to bicycle
50 loop for lock or cable
51
52 three-fold lock and/or loop for bicycles etc.
53 keys
54 latch plates
55 cable connections between locks

1. Device and process for application of an authorization, determination, designation, location as well as locking and theft proofing system of a loop that can be (intentionally and unintentionally) locked or encrypted with a lock, a locking algorithm, or an encryption mechanism or one or more lockable or encryptable loops that can be locked or encrypted with none, one or several locks, where each loop and each lock (also as a unit) carries one or more (temporal, variable or coded biometrically individually digitally cryptographically encryptable) numeric, alphanumeric, auto number or bar code that can be registered on the internet, on another (private, public, governmental or police) network or another data bank or on a mobile phone portal, or several numbers which have interactive information indices and radio functions and which, in the case of theft, criminal or unauthorized or undesired (criminal) influence, triggers an (alarm) signal and can also be used or mounted on chains or locks themselves, (motor) vehicles or bicycles (through the spokes, hubs, gear changers, etc.), kickboards, ski ties, cars, boats, aircraft, houses or boxes and cassettes or (hand) guns, computers, mobile telephones, laptops, TVs, projectors, (electronic) instruments, also especially cables, watches, clothing, (chastity) belts and naturally humans, animals (legs), and plants and can be equipped with an electrical circuit with a connection or interruption to electrical (switching) devices and can also carry one or more transmitters, transponders, transmitters, SIM cards or radio chips which give a signal to the number registered on the internet or receive it from the internet or from a cell phone/PDA and, e.g., are integrated in a screw head, nut, nail, needles, threads, knobs and/or as (theft) security system for a safety tie/link etc., that is provided on an upper and/or lower part with a loop which is locked as (theft, misappropriation, data) protection with a lock in such a way that after the destruction of the loop the top part can no longer be joined with or attached to the bottom part (motors can no longer be installed in or removed from the chassis, in which case a loop is a material or information circuit also through photoelectric barriers or magnetic or electric potential fields and also means local, temporal or legal etc. loop regions or zones or combinations of these.

2. The alarm is actuated upon the destruction of the loop as well as in the case of interruption of the power feed of the transponder (the cell phone SIM card) or a feed meter.

3. The loop has a bright luminous coating. The number of the loop is engraved with a 1 mm or 0.5 or 0.3 or 0.1 or 0.05 or 0.03 or 0.001 mm laser (penetrating or not) or is identified clearly recognizably by a Lock-Loop (™, trademark) symbol.

4. The loop can be locked or opened and/or serially or in-parallel locked/encrypted/coded and/or arranged in a combination with (a screw and/or nut with) a lock with a loop or lock itself.

5. The lock can be mounted and/or be used through, on, in, at, for, instead of the loop and vice versa. The numbers can be locked themselves, coded, blocked or made invisible.

6. The fixation of the Lock-Loop DSS to the different products with screws, rivets, cables etc. always takes place with a square 4×4 or 3 D connection system with 1 cm, 2 cm etc. side spacing.

7. The numbers, the loops, the transponders are all subjected to a technical, economical, or other classification as well as nomenclature so that they do not interfere, intersect or mutually impair each other.

8. Device in which on an upper and/or lower part at least one loop is provided which can be locked as a theft proofing measure by a lock in such a way that the top part can no longer be attached to or be separated from the bottom part or anything else brought between or into them or on the other hand conversely must even extra.

9. The loop can be locked or opened with a screw, nut, nail, needles, thread, button and nut, with a lock, with a loop itself. The loop or the screw head may in turn be locked with another loop, cap or lock mechanically and/or electronically.

10. The numbers may alternate or be combined with a time number or be plugged in or be made recognizable only with a/(its) code (name) or can be generated or exist according to an internal or external algorithm. In particular for watch dials or other indicator systems which can carry EPC tags (mini microchips) such auto-numbers are simplest to integrate. In the case of expensive products or parts (e.g. expensive watches, an EPC tag can be integrated precisely into the most expensive part or several parts.

11. For locking/encryption of the loop and/or lock the product can be combined or separated with the interface and a person. The loops, products, persons etc. can all be nested one inside the other.

12. As loops one may also use cables which, in particular, are woven/laced like coaxial cables but with insulation so that short circuiting in a very small space is no longer possible and also the cable, firmly stabilized like a safety cable, is difficult to separate/take apart.
Electronics/Radio

13. For stationary (electronic devices, houses, plants) products cables are installed as electrical circuits in the loop (e.g., EPC tags) around, in, on, for, etc. the products (the cables may themselves again possess locks or be lockable electronically and can be located with a transponder or (SIM card) radio interface.

14. In GSM UMTS-radio-free zones (underground garages, tunnels, mountains, cities, forests) W-LAN (access point), Bluetooth, wireless (local) loop or CB radio nets may assume coverage for the radio interface which are also locked and trigger an alarm locally or to a central or a mobile phone.

15. The antenna required for the (GPS, GSM etc.) radio reception is integrated in the loop and can be plugged inside or outside on the mobile or stationary object visibly or invisibly and identified non-(destructibly) or destructibly and integrated in the loop or number!

16. The radio interfaces have several loops, or a loop has several radio interfaces, which are so arranged so as to make it (no longer and) possible to devise an exactly definable electric current or circuits. It can be said (not with one technique) how many and what kind of radio interfaces are integrated! The same is true for the feed.

17. The arrangement of the numbers, the lock and the loops, transmitters and chips can be so easily constructed and configured that, although they function for years without damage, in the case of very minor damage they are destroyed or trigger an alarm. The loop, the number, the electric circuit in this way can also form a unit with the number like, e.g., a watch dial. The lock itself may form such a unit as well as any other arrangement with a loop such as screws, nuts, nails, needles, threads, buttons, rods, rivets, ring, plate, ball or box with loop and number.

18. In the case of the lock or a ball or box the latter can also additionally be locked with a normal key system or with or without radio transmission (electronically). From the lock, especially the ball or box then cables or loops emerge as loops which inside the ball or box possesses a protected transponder, transmitter or transmitter. The box or ball itself may be formed from several loops or be protected with them.

19. The individual cables or loops with insulations around the wire can be twisted or woven (like a coaxial cable) so that between the outlet and the inlet of the cable at the transmitter or the safety box no access to the cable itself is possible any longer for short circuiting the same. The transmitter can even be integrated inside the woven cable, and the individual cables may be antennas.

20. The locking of the loops and numbers can be used for monitors and radio, TV, W-LAN, telephone etc., receivers and transmitters that receive or transmit other or the same encrypted and unencrypted signals. The signals may be transmitted separately, individually or together or in a combination thereof!

21. The electric circuit in the loop can also be opened together with or without the loop in order to insert other loops and circuits or to enable an access to a locked part or a box or through a passage such as (car) doors etc.

22. The code encryption can take place via an external or internal, actively switchable-on or passively always switched-on algorithm with special software on special hardware.

23. Simple (electronic) connections (loops) from transponders in products can also go to the peripheral part with or without numbers. Thus, for example, in the case of computers or laptops all peripheral parts (drives, plug-in cards, chips, cooling devices) can be covered and tested for completeness and/or presence. The Microsoft PIN identification solutions may be used for this purpose.

24. Besides the internet itself, radio interfaces and devices, cell phones or mobiles as well as stationary W-LAN or RFID transponder devices can store and administer the numbers.

25. The loop with the number, besides the electrical circuit, may also be only an information (circuit) (e.g., locking, a code, a signal or just information), which, e.g., besides matter as a carrier contains information via light, sound, another physical or para-psychological medium. For example, every photoelectric barrier can be locked with a light wavelength code, or any magnetic or electrical potential field can also form loops.

26. W-LAN, GSM etc. transponders may receive RFID-EPC tag signals. RFID-EPC tags receive and transmit in the W-LAN frequency range and may be locked mechanically, electronically, locally, temporally, legally or a combination of these with an encryption algorithm and have a tracking or registration function with number on the internet.
Cell Phones with EPC Transponders and Fingerprint Sensors

27. The encrypted code (firewall) can be transferred from a biometric (PIN, fingerprint, acoustic signal, iris print) code or a combination of these. The recognition can be fed back vice versa.

28. The biometric code for locking the loops or numbers can be transmitted via a car key (central lock), mobile telephone or other transponder that carries a sensor pad for fingerprint recognition and has a sensor camera for iris recognition.

29. The sensor camera searches one or both black pupils and white eyeballs with iris or an installed or integrated EPC tag in the face, eye, retina, cornea or lens that is placed with at least one EPC tag on the eye. The EPC tags may be surgically implanted or lasered into the eyes. The EPC tags can project video images directly onto the lens and show directions that are directed into the macula of the eye.

30. Cameras in cell phones have a sensor with software which like a movable eye itself centers the headset in the case of video telephone conversations or centers another reference point always the face, body or another desired viewing angle (e.g., on a special EPC tag as well as with number on the internet).

31. The locking/encryption with a loop and/or lock is actuated via a radio signal (GSM, CB, FM, IR, UV, UHF etc.). In this case a certification code is sent to the product via an interface (cell phone with RIFD transponder, key, etc.). The radio interface, i.e. cell phone is and has itself like the product the or a second, third etc. loop with number. On the interface in turn another interface is installed and encrypted as (loop) with or without the first radio interface's being or used as a lockable loop etc. (e.g., key combined with mobile phone). All interfaces and products or only parts of them may be combined and adjusted individually or according to a preset algorithm. From the key a signal can be given to the mobile phone or vice versa which can or must be operated according to a preset algorithm.

32. The lockable DSS or the chip with the loop can be equipped or combined with an avalanche searching device in cell phones or another radar search function, direction indicating techniques to EPC tags, GSM chips or GPS transmitters, Recco-reflectors and transmitters etc., e.g.. in cell phones, skies, snowboards, ties/links, boots or clothing or all other products.

33. Products (radio interface) with the Lock-Loop DSS feature can transmit via W-LAN, GSM, GPS or all other radio chip (CB, walkie-talkie 446 MHz, Barryfox 457 kHz). The individual channels may in turn be locked and encrypted. Cell phones, walky-talkys etc. for multiradio (transmitting and receiving or location and locking) units can be fused together. In this case any combination of transmitting/receiving units can be chosen, whether UHF, GSM, Bluetooth, satellite telephone, DPS, DECT fixed net telephony.

34. (Radio interfaces) have both a hardware and also a software solution for the adjustment of the cheapest or best or individually desired sequence of the most suitable clarification of the forwarding of the lock, of the code, of a search function as well as a conversation whether via UHF, GSM, Bluetooth, satellite telephone, GPS, DECT or fixed net telephony. Several radio interfaces can be connected in series through several stations to enable forwarding to each other.

35. A receiver/transmitter combined with a cell phone can detect, locate, track and process the Lock-Loop or EPC tag chips. This goes through several receivers/transmitter systems (W-LAN, GSM, UHF, Bluetooth etc. The locks or authorization for Lock-Loop chips or EPC tags can be given/guided biometrically or via other authorizations from cell phones or internet-(platform).

36. The same locked numbers on the internet etc can be intermediately transferred to an independent computer/laptop/PDA/cell phone and administered without having a constant internet connection. Special memory caches store all movements or interactions with EPC tags or RAM caches, and functions are integrated in the radio interfaces.

37. For cell phones or all other PDAs etc. the numbers can be managed on an internet site such as downloaded for a “friend finder function” on cell phones, PDAs, laptops or vehicles. The “friend finder function” is a direction indicator of the type of a compass to friends or products with EPC tags in the environment or to certain places which permits the location of friends/enemies/all products and other tags or microchips, transmitters such as television transmitters or channels or loops! Naturally in this way also the loops with the numbers can be tracked! Everything can be found as well as plugged individually locked! An extra function permits every EPC tag to be tracked with it in and via several radio interfaces at defined distances.

38. 4 G cell phones have the loop-internet signal-radio tracking and locking feature, i.e. today's cell phones like the EPC tags still do not have the important locking feature (which hereby is clearly and distinctly claimed). Also GPS transponder devices or solar cells (feeds) can also possess the lockable loops (with numbers on the internet).

39. Biometric factors such as fingerprints, iris prints or voice recognition patterns as well as biological, biochemical, physiological or genome values may be taken as number and/or loop.

40. The numbers for unlocking or locking EPC tags in the products or combined with them or products integrated in them as well as all lockable products with transponders can also be entered/input by a person from memory or a data bank as well as in combination with another electronic, mechanical, physical, biometric speech code and/or via an authorization interface such as a cell phone.

41. The biometric signal of the number as an encrypted code (firewall) can be entered in the product to be locked, protected or tracked directly or indirectly or in the radio interface (cell phone) or both simultaneously.

42. A simple menu guide, similar to cell phone address lists, for a Lock-Loop list of all products, chips, EPC tags to be locked and tracked, is integrated in the radio interfaces or cell phones, which is guided with a fingerprint on the visible display sensor and executed with one or more simultaneous fingerprints and/or biometric signals.
Stand Alone Solutions for Vehicles or Mobile Products:

43. The open (Lock-Loop DSS) loops or EPC chips are integrated in vehicles as standalone devices or at the factory into the vehicles, motors, cable tree, or other parts such as radios, wheels, trailers, etc. In this case, however, the standalone device can also be plugged by the automobile owner/garage operator himself in his own vehicle! The standalone device has a receiver/transmitter from/to for alarm signals from the central radio lock and/or from the loop or chips with movement sensors or photoelectric barriers and a DSM, W-LAN or other radio transponder. In the vehicle (but also in all other products connected to/nested in it), one or more EPC tags are built or plugged in (e.g., in the engine, etc.). In addition to doors, also windows, convertible tops, trailers, etc., or other parts the products can be locked and tracked.

44. The Lock-Loop DSS stand-alone device in vehicles or all other products transmit as long as they are not stolen. After this only after authorization by the owner the devices emit short signals so that the thief cannot search for and destroy the device. In the case of locking the devices register the location by positioning to the GSM, GPS and other transmitters and if an unauthorized movement or interruption passes a loop an alarm signal is sent out.

45. Even without a radio device the EPC tags in the vehicles are sufficient to trigger an alarm signal in the case of unauthorized destruction of the loops or movement out of a defined radio range via another radio device in another vehicle or at the edge of the road or via someone else's cell phone, etc.

46. Combination of a process for a device such as a cell phone, PDA or laptop which simultaneously and/or successively independently of one another subsequently has biometry, fingerprint or speech recognition or numbers and/or other individual, personal key, code or password authorization for a “lock or open car, etc.” function. This command is sent via an RFID transmitter in a radio interface or cell phone to the EPC tags.

47. Software in the Lock-Loop DSS stand-alone device regulates and stores all received signals from the EPC tags surrounding it. By repeated locking of all EPC tags these can be brought together, thereby defining a single product. By a homologization function other EPC tags can be included or removed.

48. For bicycles a double or triple buckle with loops is affixed to the frame, which can be integrated in the frame or other components, which themselves may be loops or locks (e.g. hubs, axles, rims, seat, handlebars, hand grips, brakes, tires). In particular hub locks can be equipped with the anti-theft system!

49. Conventional bicycle locks (fork, chain or cable locks) have a GSM, GPS or EPC tag transponder integrated for location and for electronic locking of the lock. For bicycles or other locks and products not supplied with current the current supply is integrated in the hub or rim as a motion dynamo, or a magnetic disk (e.g., in the disk brake) in the wheel as an induction current generator. A movement sensor sounds an alarm in the case when the bicycle is carried away or in the case of its destruction. When the current is interrupted or deflected an alarm sounds. In the case of unauthorized removal of EPC tag-equipped components such as saddles, wheels, brakes etc. there is also an alarm. Every GSS, GPS or EPC tag transponder can be combined individually for a product, locked and tracked via the fingerprint sensor radio interface or the internet.

50. For mobile products (vehicles (stand alone solution), bicycles, laptops, projectors, etc.) the radio antenna may be installed plugged outside or inside visibly or invisibly. The hardware disk and the transponder or SIM card as receiving module are connected, together or separately, in two or several stages via encoded radio connections or with the radio antenna or antennas. The transponders, SIM cards, disks and radio antennas may themselves be encrypted/locked to each other. In particular, in products with radio and information nets be connected to transponders, to EPC tags with transponders to GSM, W-LAN nets.

51. On a (Lock-Loop DSS or EPC tag information) internet platform via computer, laptop, PDA, cell phone or radio interface all other personal, biometric, technical etc. data can be entered, administered and locked. For laptops, PDAs, cell phones and all other products with LL radio feature a license from me is required.

52. For (business) operation of the (Lock-Loop DSS or EPC tag information) internet platform etc. an international hotline is needed to answer and solve the questions and problems of the customers. Various organizations and institutions may also receive limited access to the internet platform.

53. The Lock-Loop DSS with transponder to GSM net and GPS satellites and transponders with EPC tags can be integrated as a stand-alone solution directly in (car) batteries, wire harnesses, doors or ignition (locks) or engines. In this case the “stand alone” solution is installed plugged by the installer himself (driver, garage mechanic) anywhere with one or more transponders. The EPC tags may themselves receive data and information on operation and function via radio.

54. For vehicles or laptops or all other single or multi-part products with installable transmitters/receivers other tags (microchips) can be incorporated as Lock-Loop DSS in engines, radios, wheels, chassis, mechanical or electronic components etc. so that they cannot be stolen or broken out. For this various transmitter/receivers are installed in parallel or serially in the products. In particular, every transmitter/receiver can be locked or coded with its loop and number and possess its own number on the internet which in turn is locked or coded.

55. In the case of vehicles the GSM, GPS or EPC tag transponders report all vehicle data (such as tank level, emissions, etc.) to receivers on the roads, crossings, bridges, tunnels and the Autobahn [4-lane highway] access roads, toll booths, etc, whether everything is correct. Autobahn drivers and police are informed directly if a vehicle gets onto the Autobahn as a ghost driver. In fog, slippery ice, accidents behind invisible curves, in the case of accidents and traffic jams, etc. a signal is transmitted to the following vehicles.

56. Traffic jams are reported backward from vehicle to vehicle and managed until the traffic jam is relieved with RFID transponders at the edge of the road (combined with GPS etc.). Driving goals may be entered (acoustically etc) and lead via the internet and software to breaking up traffic jams or even preventing them, because such a high traffic volume is immediately registered and reported. An RFID etc. black box registers all movements. By means of a point of emphasis calculation from driving data of the vehicles, from the braking paths via the cache memory the maximal speed and the vehicle spacing and hazardous driving situations at construction sites, in fog, rain and before dangerous curves can be calculated, determined, reported or even prevented. Excess traffic can be reported to the driver and above all demonstrated in a legally binding manner.
Safety/Rights/Special Functions

57. The radio interfaces or cell phones have both a locking and/or a searching function for products with certain EPC tags with direction indicators etc., that are adaptable to one's own/someone else's products and/or for one's own/someone else's property, new/old, cheap/expensive, electronic/physical, human/animal/physical original/counterfeit. The locking can also function from cell phones (via the internet) on stationary as well as mobile products, doors, etc.

58. The radio interface and cell phones recognize the EPC tags that are integrated in the brand label or logo, in writing or by symbol or only the base or a price bar code, in which case the latter are adjustable with other functions as only locking to original/counterfeit recognition, i.e., it can be combined with anything else such as with light (video), sound (music), movement (fresh, packaging, heat, time, storage) of consumer goods and above all foods etc. with EPC tags. Every EPC tag is registered by one of us via the internet, and secure sites (can) be tested with the label lists, locked and tracked.

59. The radio nets are also information nets via EPC tags and cell phone radio interfaces. The radio interfaces (antennas) may themselves be connected encrypted by radio or be connected encrypted via loops! The information on the EPC tag net can be locked or/and referred to for other applications by individuals and companies as well as colonies of animals, humans or above all the products themselves. Statistics from products and net operations, like all newly accumulated information from the connection with the Lock-Loop project, belongs to the finder or inventor.

60. Weapons, articles of value, instruments, body, vehicle or aircraft parts, buttons, tear seals, bands/ribbons, threads may contain a Lock-Loop or EPC tag chip which gives via a radio interface a signal to a number on the internet for checking the owner, property, physical data, wear, return expiration date and blocking. The idea and purpose is to enable the company and individual to make a simple check of all applied rights of one's own and obligations of others.

61. The loops can be locked/authorized not only for one product but also for the site, a time point or time span, the owner, a right or an obligation (e.g., for reasons of data protection).

62. Coins, paper money and credit cards can also be equipped with a (lockable) loop, a microchip or transponder and be stored with additional information on time, place, past, owner. All personal data can be called up on the lockable EPC credit card. In the event of destruction of the coins, paper money or credit cards in the case of unintentional destruction the data and values can be restored or in the case of criminal destruction the data and values are blocked until an official declaration. The coins, paper money and credit cards can therefore either be officially devalued or revalued. Any transaction of any coin and any bank note can be followed in the cell phones themselves and detected via the internet. Counterfeit money is no longer possible.

63. The (cell phone) radio interfaces as well as internet servers have quite special history caches which registers, manage, and indicates all transactions from EPC tags (money, products) according to entirely different criteria (type, time, distance, quantity, cost, individual preferences). In particular, anyone can subsequently follow and check his transferred EPC tags, even if his cell phone is lost, the other cell phones or caches in the EPC tags themselves take over because they also store and lock their numbers for an indefinite number of users.

64. The numbers on the loop can be visible or invisible, characterized physically recognizable with another recognition method, and themselves be loops or the loops be a number, an information part or whole combined with functions, codes, tasks, obligations, rights, specifications.

65. For reasons of environmental protection and pledge security all products when sold are brought into a relationship with a code number in the loop to the purchaser and owner. In the case of disposal in (public) cans, dumpsites or of destruction, transmitters can also (register) each loop (EPC tag). From this entire material flow or logistic scenarios for products, brands, firms can be administered and marketed.

66. The products can be managed via an internal or external electronic locking systems (much as the key to the lock forms a unit) (the loops can, after all, possess different (settable) numbers). That is, cell phones, fingerprint sensors, video cameras, which have a locking, authorization or other function with the other products with loops and numbers, form a unit or may naturally be separately individually viewed, used or employed. For example, cell phones, cameras, tape recorders can be placed in vehicles, theaters, concerts, lectures, sporting events etc.

67. In or on all private or public buildings RFID identification transmitters can be installed which register the EPC tags. Thus in entrance halls of railroad stations or on Autobahns and at airport terminals identification transmitters can be set up permanently or also as mobile units may run themselves via any cell phone.

68. The Lock-Loop DSS can be equipped and authorized products be used for authorization of internet, banking, property, legal accesses or for voting, elections and the like.

69. A special button or function on the cell phone etc. permits EPC tag, product or friend to receive information in 1 cm to 10 cm or 1 m etc. distance. This information is stored in a management cache according to (time, length, site, index, importance, features, wishes). A special button or function on the cell phone to allow the radio and TV channels and volumes to move forward, trigger alarms or a high voltage shock (in the case of certain or corresponding EPC tags) for dangers such as allergies, weapon possessors or in the case of dangerous persons, released animals, etc., e.g., dogs themselves.

70. On the Lock-Loop DSS via cell phone, PDA, laptop interfaces special services can be set such as the location of friends or enemies so that in the case of getting closer or further away or in the case of disappearance an alarm is triggered or another signal is transmitted, e.g., when a locked electrical potential field is entered!

71. The lockings/authorizations for the loop or EPC tags (chips) can be adjusted individually or for groups or products (e.g. for special advertising on roads, in malls, buses, trolleys, trains, etc., the cell phone headset can be adjusted according to individual view points or it emits an alarm when a criminal with a weapon appears or satellite controlled etc. movements or tours are possible through (product) parks. A button or a function takes over the cell phone or head set adjustment for TV, radio, RFID, telephone or radio reception.

72. Immediate or momentary recording of evidence with video or photographic recording (with flash) and in the surrounding area all EPC tags instant storage which also is locked directly with the number with copyright protection on the internet. This results in a simple and ingenious “time witness”, authenticity and proof standard.

73. Combination of a cell phone (radio interface) with stand-alone solution for vehicles or EPC tracking and locking. Additional functions such as garage door openers, cameras, etc., are further integrated.

74. All (e.g., for data protection and authorization reasons) loops with numbers without numbers on the internet are (themselves) lockable or on an internet site one can have all his lost products locked and published for tracking with alarm and reporting function to a great variety of parties. Radio interfaces (cell phones) and all GSM, W-LAN transponders will track all loops and numbers world wide.

75. All claims of this patent are combined with the claims of my video hit list patent and respectively combined with the claims of this patent itself.

76. Any combination of any patent, right, with this patent or with its own claims, descriptions, sentences, words is (also) possible.
